(19) United States
(12) Patent Application Publication
(10) Pub. No.: US 2020/0380446 A1
(43) Pub. Date: Dec. 3, 2020

(54) Artificial Intelligence Based Job Wages Benchmarks

(71) Applicant: ADP, LLC, Roseland, NJ (US)

(72) Inventors: Dmitry Tolstonogov, Parsippany, NJ (US); Xiaojing Wang, Parsippany, NJ (US); Lei Xia, Parsippany, NJ (US); Manish Karanjavkar, Parsippany, NJ (US); Jack Berkowitz, Parsippany, NJ (US)

(21) Appl. No.: 16/426,725

(22) Filed: May 30, 2019

(51) Int. Cl. G06Q 10/06; G06N 3/04; G06N 3/08

(52) U.S. Cl. CPC G06Q 10/06393; G06N 3/08; G06N 3/0472

(57) ABSTRACT

A predictive benchmarking of job wages is provided. Wage data is collected from a number of sources and preprocessed, wherein the wage data comprises a number of dimensions. A wide linear part of a wide-and-deep model is trained to emulate benchmarks and to memorize exceptions and co-occurrence of dimensions in the wage data. A deep part of the wide-and-deep model is concurrently trained to generalize rules for wage predictions across employment sectors based on relationships between dimensions. When a user request is received a number of wage benchmarks are forecast by summing linear coefficients produced by the wide linear part with nonlinear coefficients produced by the deep part according to parameters in a user request, and the wage benchmark forecasts are displayed.

### BACKGROUND INFORMATION

### 1. Field

The present disclosure relates generally to an improved computer system and, in particular, to creating predictive models for wage benchmarks using wide & deep artificial neural networks.

### 2. Background

Benchmarking job wage data facilitates evaluation and comparison of wage patterns within and between different companies, industry sectors, and geographical regions. Examples of benchmarks include average, median, and percentiles of annual base salary, hourly wage rates, etc.

Benchmarking is typically performed using aggregated data. However, depending on the sample sources and sample sizes, aggregation raises several potential difficulties. A common disadvantage of aggregated data is a small number of records in a group that can lead to wrong inferences. Therefore, only benchmarks with many people in a group are reliable. Large data aggregation is also expensive.

Furthermore, contextual anomalies can cause data outliers to become normal by adding more dimensions to the data, thereby affecting the reliability of the benchmarks. This can be exacerbated by missing dimension values and client base bias.

Data aggregation also presents privacy issues. Legally, only benchmarks derived from more than nine employees and four employers are allowed to be published. Sample sizes smaller than those limits allow reverse engineering of personal identities.

### SUMMARY

An illustrative embodiment provides a computer-implemented method of predictive benchmarking. The method comprises collecting wage data from a number of sources, wherein the wage data comprises a number of dimensions. The wage data is preprocessed. A wide linear part of a wide-and-deep model is then trained to emulate benchmarks and to memorize exceptions and co-occurrence of dimensions in the wage data. A deep part of the wide-and-deep model is concurrently trained to generalize rules for wage predictions across employment sectors based on relationships between dimensions. A user request is received for a number of wage benchmark forecasts, and the number of wage benchmarks are forecast, wherein linear coefficients produced by the wide linear part are summed with nonlinear coefficients produced by the deep part according to parameters in the user request. The wage benchmark forecasts are then displayed.

Another illustrative embodiment provides a system for predictive benchmarking. The system comprises: a bus system; a storage device connected to the bus system, wherein the storage device stores program instructions; and a number of processors connected to the bus system, wherein the number of processors execute the program instructions to: collect wage data from a number of sources, wherein the wage data comprises a number of dimensions; preprocess the wage data; train a wide linear part of a wide-and-deep model to emulate benchmarks and to memorize exceptions and co-occurrence of dimensions in the wage data; train a deep part of the wide-and-deep model to generalize rules for wage predictions across employment sectors based on relationships between dimensions, wherein the deep part is trained concurrently with the wide linear part; receive a user request for a number of wage benchmark forecasts forecast a number of wage benchmarks, wherein linear coefficients produced by the wide linear part are summed with nonlinear coefficients produced by the deep part according to parameters in the user request; and display the wage benchmark forecasts.

Another illustrative embodiment provides a computer program product for predictive benchmarking comprising a non-volatile computer readable storage medium having program instructions embodied therewith, the program instructions executable by a number of processors to cause the computer to perform the steps of: collecting wage data from a number of sources, wherein the wage data comprises a number of dimensions; preprocessing data; training a wide linear part of a wide-and-deep model to emulate benchmarks and to memorize exceptions and co-occurrence of dimensions in the wage data; training a deep part of the wide-and-deep model to generalize rules for wage predictions across employment sectors based on relationships between dimensions, wherein the deep part is trained concurrently with the wide linear part; receiving a user request for a number of wage benchmark forecasts; forecasting a number of wage benchmarks, wherein linear coefficients produced by the wide linear part are summed with nonlinear coefficients produced by the deep part according to parameters in the user request; and displaying the wage benchmark forecasts.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is a block diagram of a computer system for modeling in accordance with an illustrative embodiment;

FIG. 3 is a diagram that illustrates a node in a neural network in which illustrative embodiments can be implemented;

FIG. 4 is a diagram illustrating a neural network in which illustrative embodiments can be implemented;

FIG. 5 is a diagram illustrating a deep neural network in which illustrative embodiments can be implemented;

FIG. 6 depicts a wide-and-deep model trained to forecast job wage benchmarks in accordance with an illustrative embodiment;

FIG. 7 depicts an example of a benchmark cube with which illustrative embodiments can be implemented;

FIG. 8 depicts a recurrent neural network for time series of individual wages data forecasting for future periods, and for benchmark forecasting for future periods, using the benchmark builder applied to the forecasted individual wages data, in accordance with illustrative embodiments;

FIG. 9 illustrates initializing parameters with preexisting benchmark data in accordance with illustrative embodiments;

FIG. 10 is a flowchart illustrating a process for predicting wage benchmarks in accordance with illustrative embodiments; and

FIG. 11 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that wage benchmarks based on a small number of records in a group can create unreliable inferences.

The illustrative embodiments further recognize and take into account that contextual anomalies in aggregated data can allow data outliers to become normal by the addition of dimensions.

The illustrative embodiments further recognize and take into account that data privacy limitations only allow the use of wage benchmarks with more than nine employees and more than four employers.

The illustrative embodiments further recognize and take into account that it is proven that linear regression on categorical variables converges to aggregated average by minimizing mean squared errors, and to aggregated median by minimizing mean absolute errors. The illustrative embodiments further recognize and take into account that deep learning regression models can replace data aggregated wage benchmarks.

Illustrative embodiments provide a wide-and-deep neural network model to predict wage benchmarks using small sample sizes and few dimensions. A wide linear part of the wide-and-deep model is trained to emulate benchmarks and to memorize exceptions and co-occurrence of dimensions in the wage data. The model is able to both generalize rules regarding wage data and memorize exceptions. Benchmark models can be transferred to foreign job markets in which only small or aggregated data is available.

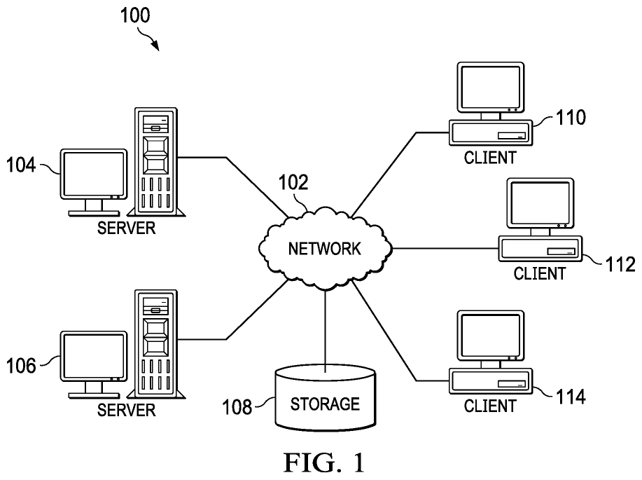

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

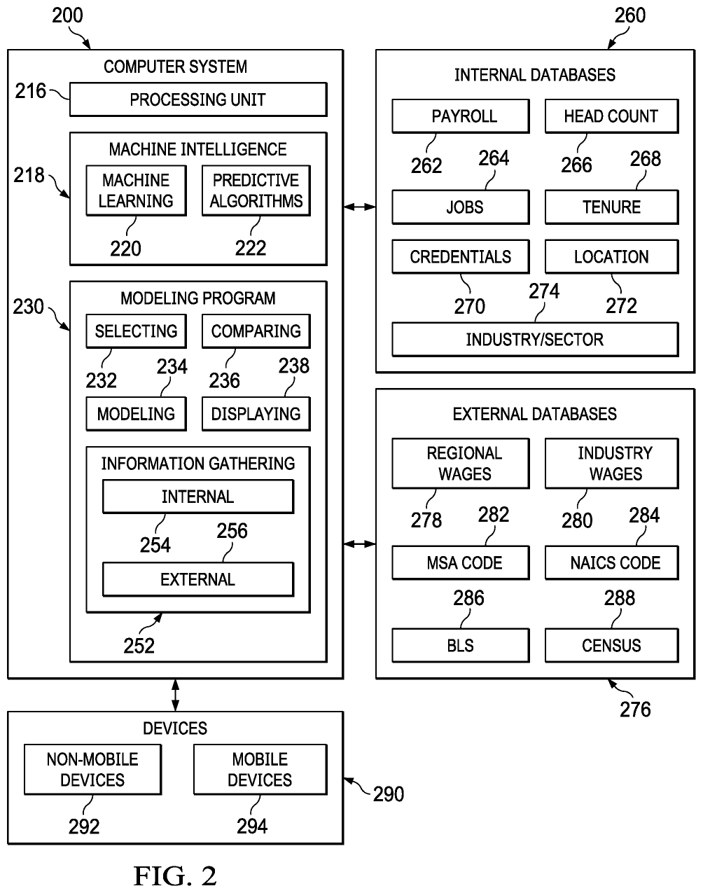

Turning to FIG. 2, a block diagram of a computer system for modeling is depicted in accordance with an illustrative embodiment. Computer system 200 is connected to internal databases 260, external databases 276, and devices 290. Internal databases 260 comprise payroll 262, job/positions within an organization 264, employee head count 266, employee tenure records 268, credentials of employees 270, location 272, and industry/sector 274 of the organization.

External databases 276 comprise regional wages 278, industry/sector wages 280, metropolitan statistical area (MSA) code 282, North American Industry Classification System (NAICS) code 284, Bureau of Labor Statistics (BLS) (or equivalent) 286, and census data 288. Devices 290 comprise non-mobile devices 292 and mobile devices 294.

Computer system 200 comprises information processing unit 216, machine intelligence 218, and indexing program 230. Machine intelligence 218 comprises machine learning 220 and predictive algorithms 222.

Machine intelligence 218 can be implemented using one or more systems such as an artificial intelligence system, a neural network, a wide-and-deep model network, a Bayesian network, an expert system, a fuzzy logic system, a genetic algorithm, or other suitable types of systems. Machine learning 220 and predictive algorithms 222 may make computer system 200 a special purpose computer for dynamic predictive modelling of employees and career paths.

In an embodiment, processing unit 216 comprises one or more conventional general purpose central processing units (CPUs). In an alternate embodiment, processing unit 216 comprises one or more graphical processing units (GPUs). Though originally designed to accelerate the creation of images with millions of pixels whose frames need to be continually recalculated to display output in less than a second, GPUs are particularly well suited to machine learning. Their specialized parallel processing architecture allows them to perform many more floating point operations per second then a CPU, on the order of 100× more. GPUs can be clustered together to run neural networks comprising hundreds of millions of connection nodes.

Modeling program 230 comprises information gathering 252, selecting 232, modeling 234, comparing 236, and displaying 238. Information gathering 252 comprises internal 254 and external 256. Internal 254 is configured to gather data from internal databases 260. External 256 is configured to gather data from external databases 276.

Thus, processing unit 216, machine intelligence 218, and modeling program 230 transform a computer system into a special purpose computer system as compared to currently available general computer systems that do not have a means to perform machine learning predictive modeling such as computer system 200 of FIG. 2. Currently used general computer systems do not have a means to accurately model employee career paths.

Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

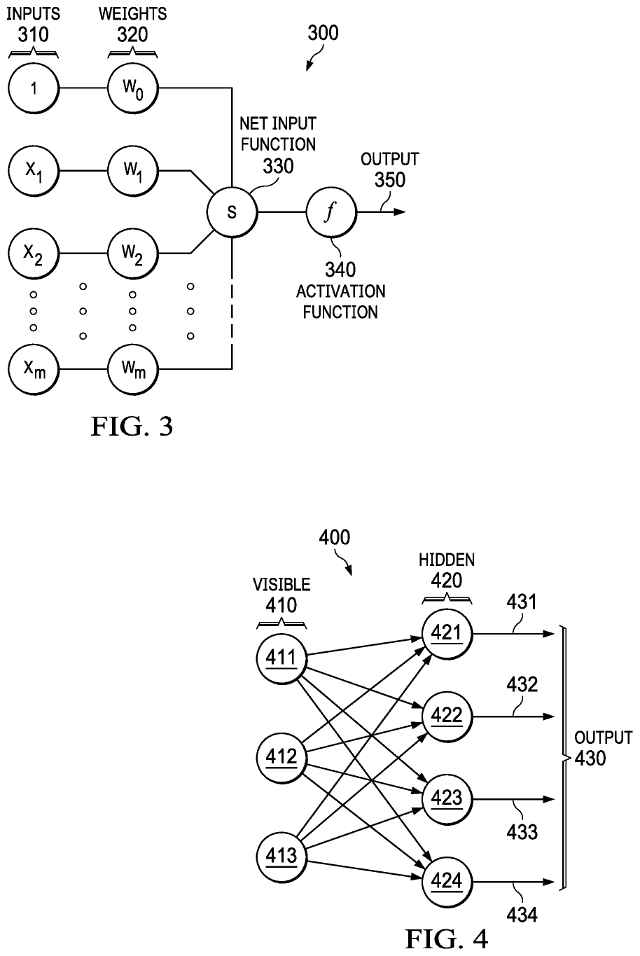

FIG. 3 is a diagram that illustrates a node in a neural network in which illustrative embodiments can be implemented. Node 300 combines multiple inputs 310 from other nodes. Each input 310 is multiplied by a respective weight 320 that either amplifies or dampens that input, thereby assigning significance to each input for the task the algorithm is trying to learn. The weighted inputs are collected by a net input function 330 and then passed through an activation function 340 to determine the output 350. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

FIG. 4 is a diagram illustrating a neural network in which illustrative embodiments can be implemented. As shown in FIG. 4, the nodes in the neural network 400 are divided into a layer of visible nodes 410 and a layer of hidden nodes 420. The visible nodes 410 are those that receive information from the environment (i.e. a set of external training data). Each visible node in layer 410 takes a low-level feature from an item in the dataset and passes it to the hidden nodes in the next layer 420. When a node in the hidden layer 420 receives an input value x from a visible node in layer 410 it multiplies x by the weight assigned to that connection (edge) and adds it to a bias b. The result of these two operations is then fed into an activation function which produces the node's output.

In symmetric networks, each node in one layer is connected to every node in the next layer. For example, when node 421 receives input from all of the visible nodes 411-413 each x value from the separate nodes is multiplied by its respective weight, and all of the products are summed. The summed products are then added to the hidden layer bias, and the result is passed through the activation function to produce output 431. A similar process is repeated at hidden nodes 422-424 to produce respective outputs 432-434. In the case of a deeper neural network, the outputs 430 of hidden layer 420 serve as inputs to the next hidden layer.

Training a neural network occurs in two alternating phases. The first phase is the “positive” phase in which the visible nodes' states are clamped to a particular binary state vector sampled from the training set (i.e. the network observes the training data). The second phase is the “negative” phase in which none of the nodes have their state determined by external data, and the network is allowed to run freely (i.e. the network tries to reconstruct the input). In the negative reconstruction phase the activations of the hidden layer 420 act as the inputs in a backward pass to visible layer 410. The activations are multiplied by the same weights that the visible layer inputs were on the forward pass. At each visible node 411-413 the sum of those products is added to a visible-layer bias. The output of those operations is a reconstruction r (i.e. an approximation of the original input x).

In machine learning, a cost function estimates how the model is performing. It is a measure of how wrong the model is in terms of its ability to estimate the relationship between input x and output y. This is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural networks can be stacked to created deep networks. After training one neural net, the activities of its hidden nodes can be used as training data for a higher level, thereby allowing stacking of neural networks. Such stacking makes it possible to efficiently train several layers of hidden nodes. Examples of stacked networks include deep belief networks (DBN), convolutional neural networks (CNN), recurrent neural networks (RNN), and spiking neural networks (SNN).

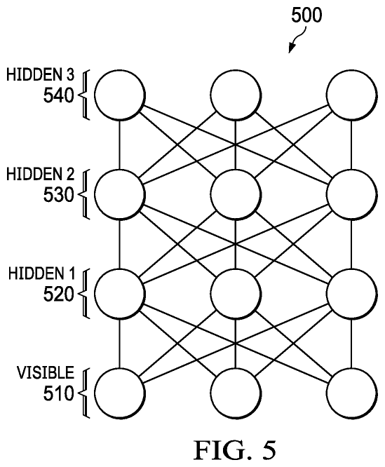

FIG. 5 is a diagram illustrating a deep neural network in which illustrative embodiments can be implemented. Deep neural network 500 comprises a layer of visible nodes 510 and multiple layers of hidden nodes 520-540. It should be understood that the number of nodes and layers depicted in FIG. 5 is chosen merely for ease of illustration and that the present disclosure can be implemented using more or less nodes and layers that those shown.

Deep neural networks learn the hierarchical structure of features, wherein each subsequent layer in the DNN processes more complex features than the layer below it. For example, in FIG. 5, the first hidden layer 520 might process low-level features, such as, e.g., the edges of an image. The next hidden layer up 530 would process higher-level features, e.g., combinations of edges, and so on. This process continues up the layers, learning simpler representations and then composing more complex ones.

In bottom-up sequential learning, the weights are adjusted at each new hidden layer until that layer is able to approximate the input from the previous lower layer. Alternatively, undirected architecture allows the joint optimization of all levels, rather than sequentially up the layers of the stack.

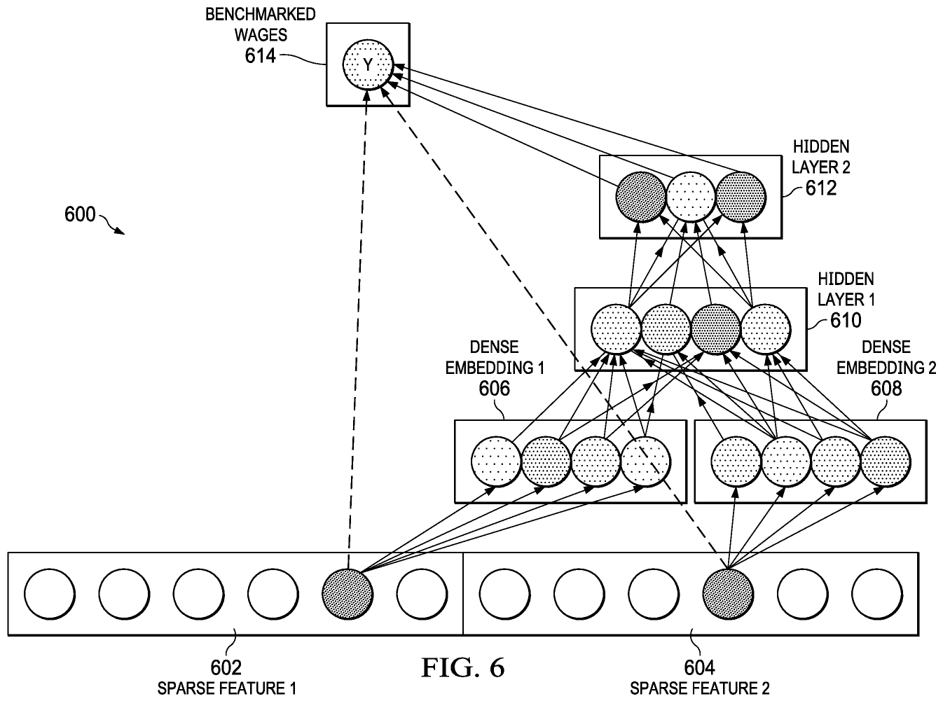

FIG. 6 depicts a wide-and-deep model trained to forecast job wage benchmarks in accordance with an illustrative embodiment. Wide-and-deep model 600 comprises two main parts, a wide linear part responsible for learning and memorizing the co-occurrence of particular dimensions within a data set and a deep part that learns complex relationships among individual dimensions in the data set. Stated more simply, the deep part develops general rules about the data set, and the wide part memorizes exceptions to those rules.

The wide linear part, comprising sparse features 602, 604, maintains a benchmark index structure and serves as a proxy for calculated benchmarks by emulating group-by-aggregate benchmarks. Features refer to properties of a phenomenon being modelled that are considered to have some predictive quality. Sparse features comprise features with mostly zero values. Sparse feature vectors represent specific instantiations of general features can could have thousands or even millions of possible values, hence why most of the values in the vector are zeros. The wide part of the wide-and-deep model 600 learns using these sparse features (e.g., 602, 604), which is why it is able to remember specific instances and exceptions.

The deep part of the wide-and-deep model 600 comprises dense embeddings 606, 608 and hidden layers 610, 612. Dense embeddings, in contrast to sparse features, comprise mostly non-zero values. An embedding is a dense, relatively low-dimensional vector space into which high-dimension sparse vectors can be translated. Embedding makes machine learning easier to do on large inputs like sparse vectors. Individual dimensions in these vectors typically have no inherent meaning, but rather it is the pattern of location and distance between vectors that machine learning uses. The position of a dimension within the vector space is learned from context and is based on the dimensions that surround it when used.

Ideally, dense embeddings capture semantics of the input by placing semantically similar inputs close together in the embedding space. It is from these semantics that the deep part of the wide-and-deep model 600 is able to generalize rules about the input values. The dense embeddings 606, 608 mapped from the sparse features 602, 604 serve as inputs to the hidden layers 610, 612.

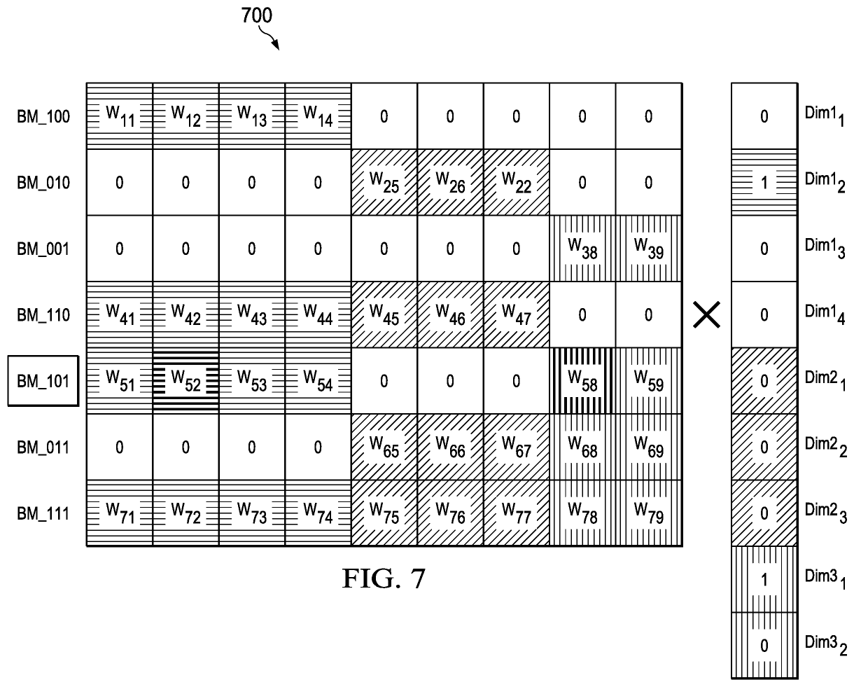

The sparse features 602, 604 represent data from a benchmark cube or outside resources such as BLS data. FIG. 7 depicts an example of a benchmark cube 700 with which illustrative embodiments can be implemented. If there is enough evenly distributed data in a cell of benchmark cube 700, the wide linear part of model 600 is sufficient because the benchmark cube 700 equals linear regression coefficients, and generalization is small. However, for most cells this is not true. If there is no data in a cell, linear regression coefficients are zeros, and the benchmark has to be derived from generalization by the deep part of the model that learns from bigger/similar/close locations, similar jobs, bigger/close industries, etc. If there is some small or odd (exceptional) data in a cell, which is typically most often the case, the benchmark is derived by a sum of linear regression coefficients from the wide part of the model and nonlinear coefficients representing generalization by the deep part of the model.

For example, if the benchmark cube 700 provides an annual base salary of $100,000, calculated as an average of nine employees with salaries of approximately $90,000 and one with a salary of $190,000, the deep part of the model might identify the one with a salary of $190,000 does not match the group (i.e. outlier). Therefore, taking this exception into account, the wide-and-deep model 600 makes a downward adjustment of its predicted annual base salary by $10,000.

The wide part linear part of the model 600 helps train the deep part through residual learning. Residuals are differences between observed and predicted values of data (i.e. errors), which serve as diagnostic measurements when assessing the accuracy of a predictive model.

Left to itself, the linear wide part would overfit predictions by learning the specific instances represented in the sparse features 602, 604. Conversely, by itself the deep part would over generalize from the dense embeddings 606, 608, producing rules that are over or under inclusive in their predictions. Therefore, the wide-and-deep model 600 trains both parts concurrently by feeding them both into a common output unit 614. During learning, the value of predicted benchmarked wages 614 is back propagated through both the wide part and deep part. The end result is a model that can accurately predict results from general rules while able to account for specific exceptions to those rules.

The wide-and-deep model 600 is trained using transfer learning, wherein the model is trained from previously known benchmarks rather than from scratch. In transfer learning, knowledge gained while solving one problem is applied to a different but related problem. Using the Benchmark Cube 700 and LBS/Census data, the model 600 is taught that some dimension values can be “any.” Then the model 600 is trained on employee core data with wages as outputs.

For dimensions where existing data is small or missing, coefficients of the wide-linear part of the model are initialized by zeros. Since there is no data to propagate through coefficients relates to cell with no data, they are not updated and keep zero values. However, coefficients for the nonlinear deep part of the model are trained to generalize data to similar or larger areas, broader industries or sectors, similar jobs, etc. Therefore, the deep part of model 600 that learns dimension interactions will produce reasonable benchmark values by generalization for cells with no data. Benchmarks with available data use both the linear part of the model (original benchmark values) and the generalization part.

For the dense embeddings 606, 608 cross terms (second order interactions) provide sharing information between pairs of dimensions. For example, some jobs are related to particular industries, and some industries are related to particular locations, etc. Dimension embeddings 606, 608 map benchmark dimensions from high-dimensional sparse vectors to lower-dimensional dense vectors in such a way that categories predefined as similar to each other have close values within a predefined proximity at one or more coordinates. For example, for a job dimension the coordinates might be: necessary education, from middle school to PhD; skills, from low to high; experience, from low to high; service/development; office/field work; intellectual/labor; front/back office, etc.

The hidden layers 610, 612 learn complex interactions in all dimensions. In a recurrent deep network, history of earnings captures historical patterns and trends in earning to forecast benchmarks to the future.

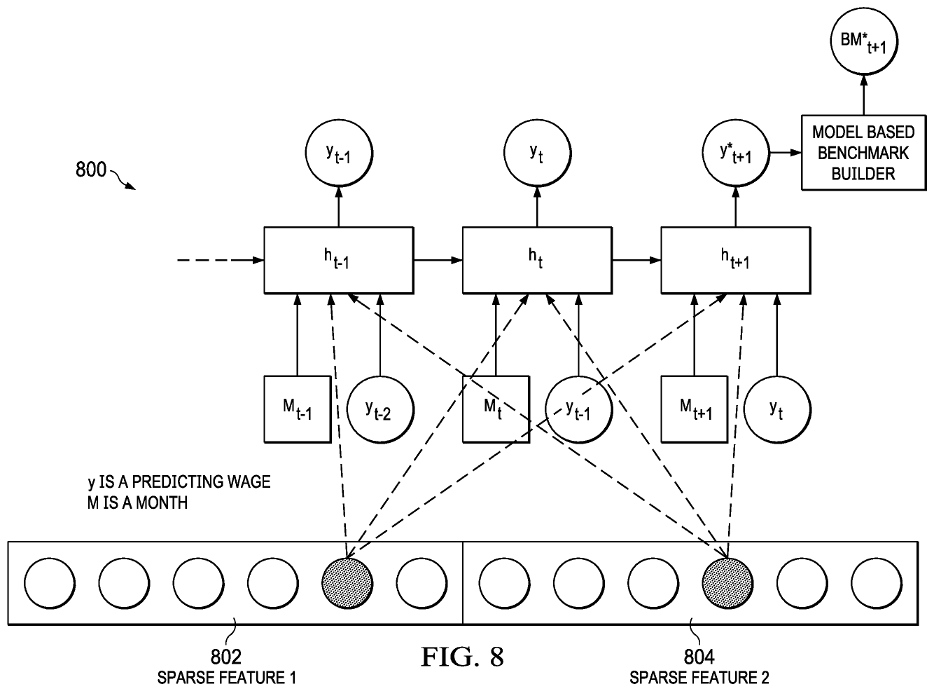

FIG. 8 depicts a recurrent neural network (RNN) for time series of individual wages data forecasting for future periods, and for benchmark forecasting for future periods, using the benchmark builder applied to the forecasted individual wages data, in accordance with illustrative embodiments. Individual wage time series forecasts from RNN 800 serve as inputs for the wide-and-deep model 600. At each time step t, inputs to the RNN network 800 comprise benchmark dimension values 802, 804, row metric values yₜ₋₂, yₜ₋₁, yₜ (e.g., annual base salary for each employee), month Mₜ₋₁, Mₜ, Mₜ₊₁ as well as the previous network output hₜ₋₁, hₜ, hₜ₊₁.

The outputs yᵢ to the network are metrics values for the next period, repeated for each benchmark dimension value. For the first time step t=1, previous step metrics and network outputs are set to zeros.

In an embodiment, there are two options as to what to forecast. The first option comprises point forecasts for benchmark averages and percentiles as separate outputs. The second option comprises predicted parameters (e.g., mean and variance) of the probability distribution for the next time point. Percentiles can be obtained from Gaussian distribution with these parameters.

To handle historical data, a custom layer can be built into the wide-and-deep model before the RNN layers to calculate the level and seasonality for each time series using the Holt-Winters method. These parameters are per-dimension combination specific, while the RNN is global and trained on all series (i.e. hierarchical model).

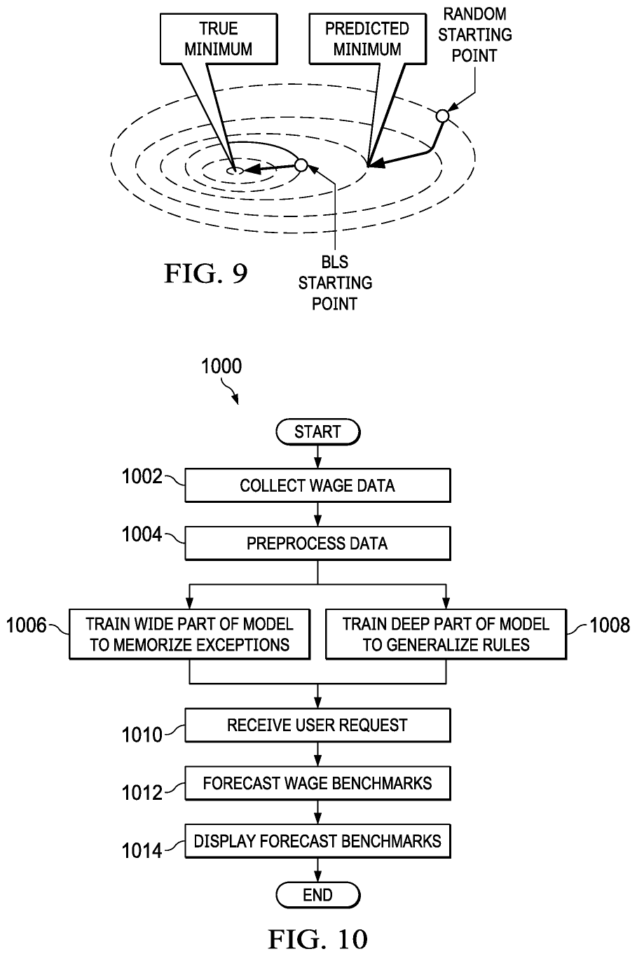

FIG. 9 illustrates initializing parameters with preexisting benchmark data in accordance with illustrative embodiments. With small amounts of data in a group, it is difficult to use gradient descent to attain the loss function minimum for few steps (few parameters' updates). Therefore, multiple epoque iterations are required to approach the minimum.

However, assuming benchmarks are sums of linear regression coefficients, it follows that true linear regression coefficient values are located near preexisting correspondent benchmark values obtained from proprietary data and BLS (or equivalent public) resources. Therefore, by starting learning from these “pre-trained” points, rather than from random ones, produces more accurate results. This is an example of transfer learning, in which preexisting results from another method (aggregating) are reused for a new but related purpose.

FIG. 10 is a flowchart illustrating a process for predicting wage benchmarks in accordance with illustrative embodiments. Process 1000 begins by collecting wage data from a number of data sources (step 1002). These sources can include employers. Gaps in the data can be filled with publicly available data such as that provided by the U.S. BLS and other equivalent public resources in other jurisdictions globally. The data is then preprocessed (step 1004). Preprocessing can comprise, e.g., cleaning, instance selection, normalization, transformation, feature extraction, feature selection, and other preprocessing methods used in machine learning.

The collected, preprocessed wage data is then used to concurrently train both a wide linear part and a deep part of a wide-and-deep neural network model. The wide linear part of the wide-and-deep model is trained to emulate benchmarks and to memorize exceptions and co-occurrence of dimensions in the wage data (step 1006). The deep part of the model is trained to generalize rules for wage predictions across employment sectors based on relationships between dimensions (step 1008). The dimensions of the wage data used by the wide-and-deep model can include, but are not limited to, region, subregion, work state, metropolitan and micropolitan statistical area (CBSA) codes, combined metropolitan statistical area (CSA) codes, North American Industry Classification System (NAICS) codes, industry sector, industry subsector, industry supersector, industry combo, industry crosssector, employee headcount band, employer revenue band, job title, occupation (O*NET), job level, and tenure.

After the wide-and-deep model is trained, the system receives a user request for a number of predicted wage benchmarks (step 1010). Benchmarks can include, but are not limited to, average annual base salary, median annual base salary, percentiles of annual base salary, average hourly rate, median hourly rate, and percentiles of hourly rate.

The wide-and-deep model forecasts the wage benchmarks in response to the user request by summing linear coefficients produced by the wide linear part with nonlinear coefficients produced by the deep part according to parameters in the user request (step 1012). The wide-and-deep model uses linear regression to calculate average base salary. To calculate percentile of base salary the wide-and-deep model uses quartile regression. The system then displays the predicted benchmark forecasts (step 1014).

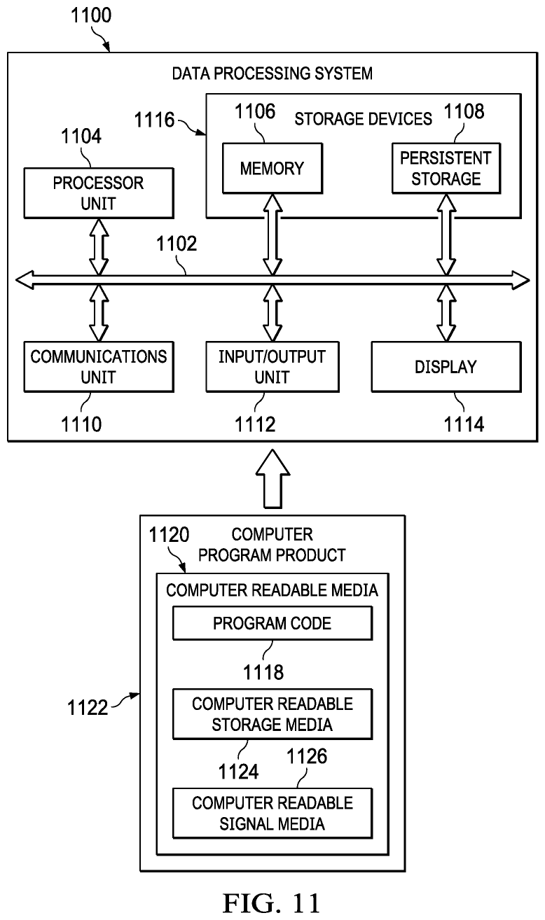

Turning now to FIG. 11, an illustration of a block diagram of a data processing system is depicted in accordance with an illustrative embodiment. Data processing system 1100 may be used to implement one or more computers and client computer system 111 in FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (CPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1116, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Alternatively, program code 1118 may be transferred to data processing system 1100 using computer-readable signal media 1126.

Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art.

Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of predictive benchmarking, the method comprising:
collecting, by a number of processors, wage data from a number of sources, wherein the wage data comprises a number of dimensions;
preprocessing, by a number of processors, the wage data;
training, by a number of processors, a wide linear part of a wide-and-deep model to emulate benchmarks and to memorize exceptions and co-occurrence of dimensions in the wage data;
training, by a number of processors, a deep part of the wide-and-deep model to generalize rules for wage predictions across employment sectors based on relationships between dimensions, wherein the deep part is trained concurrently with the wide linear part;
receiving, by a number of processors, a user request for a number of wage benchmark forecasts;
forecasting, by a number of processors, a number of wage benchmarks, wherein linear coefficients produced by the wide linear part are summed with nonlinear coefficients produced by the deep part according to parameters in the user request; and
displaying, by a number of processors, the wage benchmark forecasts.

2. The method of claim 1, wherein wage benchmarks comprise at least one of:
average annual base salary;
median annual base salary;
percentiles of annual base salary;
average hourly rate;
median hourly rate; or
percentiles of hourly rate.

3. The method of claim 2, wherein the wide-and-deep model uses linear regression to calculate average base salary.

4. The method of claim 2, wherein the wide-and-deep model uses quartile regression to calculate percentile of base salary.

5. The method of claim 1, wherein the dimensions comprise at least one of:
region;
subregion;
work state;
metropolitan and micropolitan statistical area codes;
combined metropolitan statistical area codes;
North American Industry Classification System codes;
industry sector;
industry subsector;
industry supersector;
industry combo;
industry crosssector;
employee headcount band;
employer revenue band;
job title;
occupation;
job level; or
tenure.

6. The method of claim 1, wherein the wide-and-deep model is trained through transfer learning.

7. The method of claim 1, wherein the linear wide part of the model assists the deep part of the model with residual learning.

8. The method of claim 1, wherein cross terms provide sharing information between pairs of dimensions, and wherein dimensions are added to correct for the outliers in the wage data.

9. The method of claim 1, wherein dimension embeddings map benchmark dimensions to lower-dimensional vectors, wherein categories predefined as similar to each other have values within a predefined proximity at one or more coordinates.

10. A system for predictive benchmarking, the system comprising:
a bus system;
a storage device connected to the bus system, wherein the storage device stores program instructions; and
a number of processors connected to the bus system, wherein the number of processors execute the program instructions to:
collect wage data from a number of sources, wherein the wage data comprises a number of dimensions;
preprocess the wage data;
train a wide linear part of a wide-and-deep model to emulate benchmarks and to memorize exceptions and co-occurrence of dimensions in the wage data;
train a deep part of the wide-and-deep model to generalize rules for wage predictions across employment sectors based on relationships between dimensions, wherein the deep part is trained concurrently with the wide linear part;
receive a user request for a number of wage benchmark forecasts
forecast a number of wage benchmarks, wherein linear coefficients produced by the wide linear part are summed with nonlinear coefficients produced by the deep part according to parameters in the user request; and
display the wage benchmark forecasts.

11. The system of claim 10, wherein wage benchmarks comprise at least one of:
average annual base salary;
median annual base salary;
percentiles of annual base salary;
average hourly rate;
median hourly rate; or
percentiles of hourly rate.

12. The system of claim 11, wherein the wide-and-deep model uses linear regression to calculate average base salary.

13. The system of claim 11, wherein the wide-and-deep model uses quartile regression to calculate percentile of base salary.

14. The system of claim 10, wherein the dimensions comprise at least one of:
region;
subregion;
work state;
metropolitan and micropolitan statistical area codes;
combined metropolitan statistical area codes;
North American Industry Classification System codes;
industry sector;
industry subsector;
industry supersector;
industry combo;
industry crosssector;
employee headcount band;
employer revenue band;
job title;
occupation;
job level; or
tenure.

15. The system of claim 10, wherein the wide-and-deep model is trained through transfer learning.

16. The system of claim 10, wherein the linear wide part of the model assists the deep part of the model with residual learning.

17. The system of claim 10, wherein cross terms provide sharing information between pairs of dimensions, and wherein dimensions are added to correct for the outliers in the wage data.

18. The system of claim 10, wherein dimension embeddings map benchmark dimensions to lower-dimensional vectors, wherein categories predefined as similar to each other have values within a predefined proximity at one or more coordinates.

19. A computer program product for predictive benchmarking, the computer program product comprising:
a non-volatile computer readable storage medium having program instructions embodied therewith, the program instructions executable by a number of processors to implement a neural network to perform the steps of:
collecting wage data from a number of sources, wherein the wage data comprises a number of dimensions;
preprocessing the wage data;
training a wide linear part of a wide-and-deep model emulate benchmarks and to memorize exceptions and co-occurrence of dimensions in the wage data;
training a deep part of the wide-and-deep model to generalize rules for wage predictions across employment sectors based on relationships between dimensions, wherein the deep part is trained concurrently with the wide linear part;
receiving a user request for a number of wage benchmark forecasts;
forecasting a number of wage benchmarks, wherein linear coefficients produced by the wide linear part are summed with nonlinear coefficients produced by the deep part according to parameters in the user request; and
displaying the wage benchmark forecasts.

20. The computer program product of claim 19, wherein wage benchmarks comprise at least one of:
average annual base salary;
median annual base salary;
percentiles of annual base salary;
average hourly rate;
median hourly rate; or
percentiles of hourly rate.

21. The computer program product of claim 20, wherein the wide-and-deep model uses linear regression to calculate average base salary.

22. The computer program product of claim 20, wherein the wide-and-deep model uses quartile regression to calculate percentile of base salary.

23. The computer program product of claim 19, wherein the dimensions comprise at least one of:
region;
subregion;
work state;
metropolitan and micropolitan statistical area codes;
combined metropolitan statistical area codes;
North American Industry Classification System codes;
industry sector;
industry subsector;
industry supersector;
industry combo;
industry crosssector;
employee headcount band;
employer revenue band;
job title;
occupation;
job level; or
tenure.

24. The computer program product of claim 19, wherein the wide-and-deep model is trained through transfer learning.

25. The computer program product of claim 19, wherein the linear wide part of the model assists the deep part of the model with residual learning.

26. The computer program product of claim 19, wherein cross terms provide sharing information between pairs of dimensions, and wherein dimensions are added to correct for the outliers in the wage data.

27. The computer program product of claim 19, wherein dimension embeddings map benchmark dimensions to lower-dimensional vectors, wherein categories predefined as similar to each other have values within a predefined proximity at one or more coordinates.
